(19) United States
(12) Patent Application Publication
(10) Pub. No.: US 2007/0160325 A1
(43) Pub. Date: Jul. 12, 2007

(54) Angle-tunable transmissive grating

(76) Inventors: Hyungbin Son, Cambridge, MA (US); Jing Kong, Winchester, MA (US); Ramachandra Dasari, Lexington, MA (US); Mildred Dresselhaus, Arlington, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/482,545

(22) Filed: Jul. 7, 2006

Related U.S. Application Data
(60) Provisional application No. 60/758,044, filed on Jan. 11, 2006.

(51) Int. Cl. G02B 6/34; H01S 3/08

(52) U.S. Cl. 385/37; 372/102

(57) ABSTRACT

A tunable transmissive grating comprises a transmissive dispersive element, a reflective element, and an angle θ formed between the two elements. A first optical path is formed according to the angle θ, wherein light dispersing from the dispersive element is directed onto the reflective element and reflects therefrom. At least one element is rotatable about a rotational center to cause a second optical path and thereby tune the wavelength of the light reflecting from the reflective element. Both elements can be rotatable together around a common rotational center point according to certain embodiments, and/or each element can be independently rotated around a rotational axis associated only with that element. According to some embodiments, the relative angle θ formed between the elements is held constant; however, in other embodiments θ can vary.

### CROSS REFERENCE TO RELATED APPLICATIONS

This application claims the priority of U.S. Provisional Application No. 60/758,044 filed Jan. 11, 2006 entitled, ANGLE-TUNABLE TRANSMISSIVE GRATING. The entire content of the above application is being incorporated herein by reference.

### BACKGROUND OF THE INVENTION

New types of transmissive gratings are available with higher efficiency than reflective gratings. Traditionally, reflective gratings have been preferred over transmissive gratings for various optical instruments as their dispersive elements. Reflective gratings have been a key component of various optical instruments such as monochrometers, tunable laser cavities, and beam stretcher/compressors. Not only can reflective gratings be easily tuned, until recently they also promised higher diffraction efficiencies than transmissive gratings.

Transmissive gratings developed recently, however, such as Volume Holographic Transmission (VHT) gratings and Fused Silica (FS) gratings, are equal or superior to reflective gratings in almost every aspect: diffraction efficiency, bandwidth, polarization dependence, stability and cost. Thus, these transmissive gratings are quickly replacing reflective gratings in many fixed-wavelength applications.

Owing to their transmissive nature, however, transmissive gratings cannot be tuned the same way that reflective gratings are tuned, and this has limited the use of transmissive gratings to fixed-wavelength applications in many optical systems. This limitation can be understood by considering the relevant geometry and grating equations.

The grating equation for a reflective grating is given by

nλ=d·(sin α+sin β) (1)

which can be rewritten to:

$$n λ = 2 d \cdot ( sin ( \frac{α + β}{2} ) \cdot cos ( \frac{α - β}{2} ) ) \qquad ( 2 )$$

where integer n is the diffraction order, λ is the wavelength, d is the groove spacing, and α and β are the angles of incidence and diffraction relative to the grating normal, respectively. In most instruments using a reflective grating, the entrance and the exit beam directions are fixed; therefore, the following condition is always satisfied:

α−β=const. (3)

When the reflective grating is rotated, α and β satisfy the following condition:

α+β=2γ (4)

where γ is the angular coordinate of the grating normal and is defined to be zero when the grating normal bisects the input and exit beams. Substituting equation (3) and equation (4) into equation (2), it is apparent that the wavelength of the diffracted beam can be tuned by turning the reflective grating such that

nλ=2d·(sin γ·const.) (5)

In the case of an instrument using a transmissive grating, a different constraint holds, assuming fixed entrance and exit beam directions (see FIG. 1):

α+β=const. (6)

Referring to FIG. 1, illustrating a transmissive grating 1, angles α and β are angles of incidence and diffraction relative to the grating normal 5, respectively, and angle γ is the angular coordinate of the grating, defined to be zero when α=β (the Littrow condition). Input slit 3 and output slit 4 create fixed directions for the entrance beam 7 and the exit beam 8, respectively. When the grating 1 is rotated, angles α and β satisfy the following condition

β−α=2γ (7)

By inserting equation (6) and equation (7) into the grating equation (2), the wavelength of the diffracted beam 8 is given by the following:

nλ=2d·(const.·cos γ) (8)

In reality, gratings perform best around γ=0 and the diffraction efficiency can drop quickly as γ moves away from zero. However, from equation (8), one can see that the wavelength has little dependence on the angle of grating 1 around γ=0. This implies that a transmissive grating such as shown in FIG. 1 cannot be tuned efficiently.

Therefore, there is a need for improving the ability to tune a transmissive grating efficiently. Further there is a need for developing tunable transmissive gratings that can be used in existing optical systems with minimal design changes, in order to achieve better performance in these optical systems with minimal cost and effort.

### SUMMARY OF THE INVENTION

The invention relates to the use of a transmissive dispersive element for tunable-wavelength applications. By taking advantage of the transmissive nature of the transmissive dispersing element such as a grating, many optical designs can be simplified and improved. The invention provides improved optical efficiency, broad bandwidth, thermal stability, lower polarization dependence, spectral purity at a lower cost.

A preferred embodiment of the invention provides for an optical apparatus for tuning wavelengths of light through a transmissive dispersive element. The apparatus includes a transmissive dispersive element, a reflector, a relative angular position, θ, formed between the dispersive element and the reflector, an optical path comprising an input beam, a diffracted beam and a reflected diffracted beam. In a preferred embodiment, the transmissive dispersive element can be a transmissive grating that diffracts the input beam and the reflector can be a rotatable mirror. Light passing from the transmissive grating is directed onto the mirror according to the relative angular position, θ. Rotating the mirror and/or the grating relative to the input beam efficiently tunes the wavelength of the reflected diffracted beam.

In a further preferred embodiment of the invention the apparatus can include a transmissive dispersive element having a first planar axis and a reflective element having a second planar axis. The planes can be parallel, but preferably the axes intersect along a line of axial intersection. An angle, θ, is formed between the planar axes. At least one of the elements is rotatable about a rotational axis. If only a single element is rotatable, then the rotational axis can lie on or off the element's axis. Preferably the rotational axis that lies on the element's axial plane. If both elements are rotatable, then each may have an independent rotational axis lying (on or off) each element's planar axis. Preferably, however, both elements are rotatable about a common rotational axis coincides with the line of axial intersection between the two planar axes. An important advantage of this embodiment of the invention is that the input and output beams remain stationary, however the wavelength of the output beam is tuned over a range of wavelengths (e.g. over a range of 0-20 nm) during joint rotation of the dispersive element and reflector without substantial loss in efficiency. Thus, a relative angular movement between the input beam path and the dispersive element will result in a tuning of the wavelength of the output beam. Tuning over a range of up to 40 nm can be made with less than a 10% drop in efficiency, for example.

A first optical path comprises an input beam dispersing from the transmissive dispersive element onto the reflective element to create a reflected dispersed beam reflecting from the reflective element. An angle β′ is formed between the reflected-dispersed beam and the normal to the axis of the dispersive element. A second optical path is formed by rotating at least one of the elements to alter angle α and/or β′, such that light passing from the dispersive element is directed onto the reflective element at a different angle than according to the first optical path. The change from the first to the second optical path tunes the wavelength of the output beam. The dispersive element can be a transmissive grating that diffracts the input beam and the reflector can be a mirror.

A preferred embodiment can provide for an apparatus that comprises a transmissive dispersive element, a reflector, first angular positions of the dispersive element and the reflector, and at least second angular positions of the dispersive element and the reflector. A first optical path is defined by light dispersing from the dispersive element directed onto the reflector according to the first angular positions. A second optical path is defined by light dispersing from the dispersive element that is directed onto the reflector according to the second angular positions. The movement of the dispersive element and/or the reflector causes light transmitted through the dispersive element to be redirected from the first optical path to the second optical path. A further embodiment provides for such an apparatus wherein a change in wavelength of a light beam reflecting from the reflector is tunable by the movement of the dispersive element and/or the reflector.

Another preferred embodiment of the invention provides for an apparatus wherein the movement of the dispersive element and the reflector is a rotation about a rotational axis. Further, a preferred embodiment of the invention provides for the movement of the dispersive element and the reflector being a rotation about a rotational joint fixedly adjacent or attached to the dispersive element and the reflector. Further preferred embodiments of the invention provide for the reflector to be unattached from the dispersive element and for the reflector and/or the dispersive element to be rotatable relative to each other. The rotational axis can be the intersection of a first plane projecting from the dispersive element and a second plane projecting from the reflector, said axis being the same for both the first and second relative angular positions.

Preferred embodiments of the invention provide a method for tuning transmissive gratings comprising providing a rotatable reflector that is optically and angularly coupled to a transmissive grating, the reflector positioned downbeam from the grating, controlling and/or changing the relative angle between the grating and reflector and thereby tuning the wavelength of the diffracted beam reflected from the reflector.

The invention provides further for using such methods to tune transmissive gratings in existing optical systems, thereby achieving better performance in these optical systems with minimal cost and effort. For example, the invention can provide for retrofitting traditional instruments with the tunable transmissive gratings. Thus, many optical instruments such as spectrometers can have a tunable element described herein installed to provide a compact wavelength tunable system.

A preferred embodiment of the invention provides a method of using a tunable transmissive grating apparatus as described above to angle-tune a transmissive grating in a tunable monochrometer, in a tunable laser cavity, or in a single, double or triple spectrometer.

A further embodiment of the invention provides for a tunable transmissive grating apparatus using a transmissive grating that is a Volume Holographic Transmission (VHT) or a Fused Silica (FS) grating.

Further, preferred embodiments of the invention provide for a tunable transmissive grating comprising a transmissive dispersive element, for example such as a transmissive grating, coupled with a reflector, for example such as a mirror, wherein collimators are placed in the optical path before the dispersive element and in the optical path downbeam of the reflector.

Embodiments of the invention provide for efficiency improvements of 20˜30% for any type of grating based monochrometer, of about 100% for triple monochrometers, and of 20˜30% in tunable laser cavities, along with spectral purity improvement and power handling capability increasing by about a factor of 10.

### BRIEF DESCRIPTION OF THE FIGURES

FIG. 1 illustrates a transmissive grating and fixed entrance and exit beam directions, showing the angles α, β, and γ used for associated grating equations.

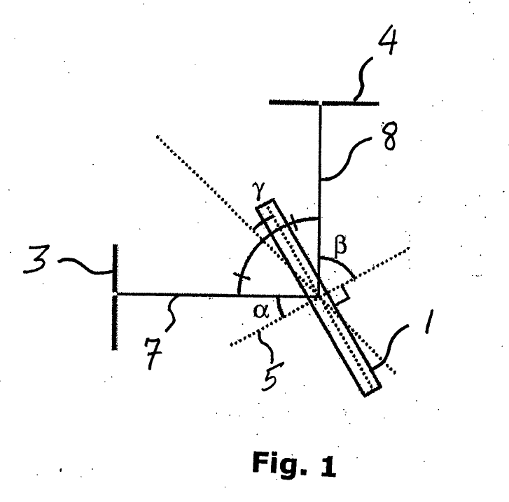

FIG. 2 illustrates a monochrometer using a tunable transmissive grating according to an embodiment of the invention.

FIG. 3 illustrates a monochrometer using a tunable transmissive grating with collimators according to an embodiment of the invention.

FIG. 4 shows an example of a further embodiment of the invention.

FIG. 5 shows an example of a laser cavity using a tunable transmissive grating according to an embodiment of the invention.

FIG. 6 shows an example of a tunable diode laser cavity using a tunable transmissive grating according to an embodiment of the invention.

FIG. 7 illustrates a relationship between grating efficiency expressed as output power and tunable wavelength in a diode laser cavity using a tunable transmissive grating according to an embodiment of the invention, where the angle of the grating-mirror assembly to achieve the tuning to a specific wavelength is also depicted.

FIG. 8 illustrates an efficiency curve for a grating used in one embodiment of the invention, showing comparison of the efficiency with the grating rotating with the mirror to tune the wavelength versus efficiency with the grating fixed while the mirror rotates to tune the wavelength.

### DETAILED DESCRIPTION

The invention relates to the use transmissive dispersive elements for tunable-wavelength applications. By taking advantage of the transmissive nature of the transmissive dispersing elements such as gratings, many optical designs can be simplified and improved.

In general, multiple embodiments of the invention provide for an angle-tunable assembly comprising a transmissive dispersive element and a reflective element, wherein at least one element is rotatable about a rotational center to tune the wavelength of a beam of light following an optical path through the transmissive dispersive element and onto the reflective element. Both elements can be rotatable together around a common rotational according to certain embodiments, and/or each element can be independently rotated around a rotational axis associated only with that element. Planar axes of orientation associated with each element can intersect at a line of intersection, which line can coincide with a rotational axis. A relative angle θ formed between the elements is to be held constant while angle-tuning according to some embodiments; however, according to other embodiments θ can be variable, all according to the invention. The invention will now be illustrated in more detailed with reference to the drawings.

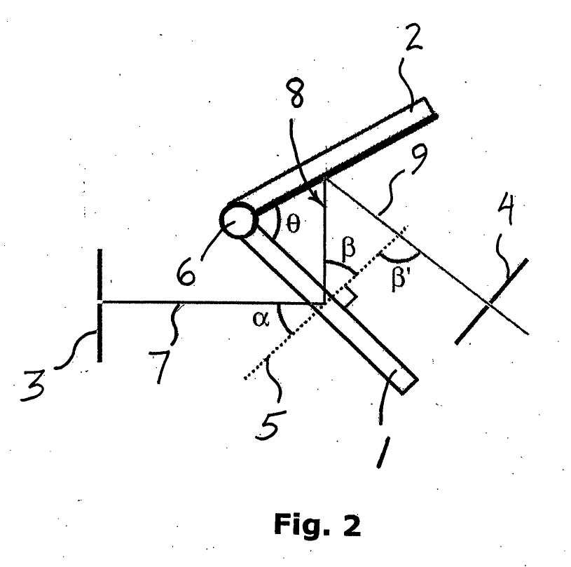

Referring to FIG. 2, a preferred embodiment of the invention provides for an optical apparatus for tuning wavelengths of light through a transmissive dispersive element, wherein the apparatus comprises a transmissive dispersive element 1, a reflector 2, a relative angular position, θ, formed between the dispersive element 1 and the reflector 2, an optical path comprising an input beam 7, a diffracted beam 8 and a reflected diffracted beam 9. The dispersive element 1 can be, for example, a transmissive grating that diffracts the input beam 7, and the reflector 2 can be, for example, a mirror. Light passing from the dispersive element 1 is directed onto the reflector 2 according to a relative angular position, for example θ₁.

Referring still to FIG. 2, taking as an example wherein the dispersive element 1 is a grating and the reflector 2 is a mirror, to simplify the discussion of geometry, the grating 1 and mirror 2 are fixedly joined at one end by a rotating joint 6 which operates as a rotational center point. Input beam 7 entering through entrance slit 3 follows an optical path to the transmissive grating 1, wherein the beam is diffracted through transmissive grating 1 to become diffracted beam 8. Diffracted beam 8 then follows an optical path onto mirror 2, whereupon beam 8 is reflected from mirror 2 as reflected diffracted beam 9, which beam 9 exits through exit slit 4. The diffracted beam 8 reflects from the mirror 2. The angle, β′, of the outgoing beam 9 from the grating assembly, measured between the normal vector to the grating axis and the outgoing beam 9, can be derived from simple geometric considerations:

β′=2θ−β (9)

where θ is the angle between the grating 1 and the mirror 2, and β is the angle measured between the normal vector to the grating axis and the dispersed beam 8 (see FIG. 2). The assumption that the directions of the entrance beam 7 and the exit beam 8 are fixed puts the following constraint on the angles:

α+β′=α−β+2θ=const. (10)

which means

α−β=const. (11)

such that rotating mirror 2 and grating 1 around the rotational center point 6 with θ remaining constant maintains the constraint (α+β′=constant). Therefore, the same constraint is obtained as in the case of a reflective grating. By designing the angle θ and the location of the exit slit 4 such that α−β=0, the Littrow condition is always satisfied. In this case the wavelength of the reflected diffracted beam 9 is simply given by:

$$n λ = 2 d \cdot ( sin ( \frac{α + β}{2} ) ) = 2 d \cdot sin α \qquad ( 12 )$$

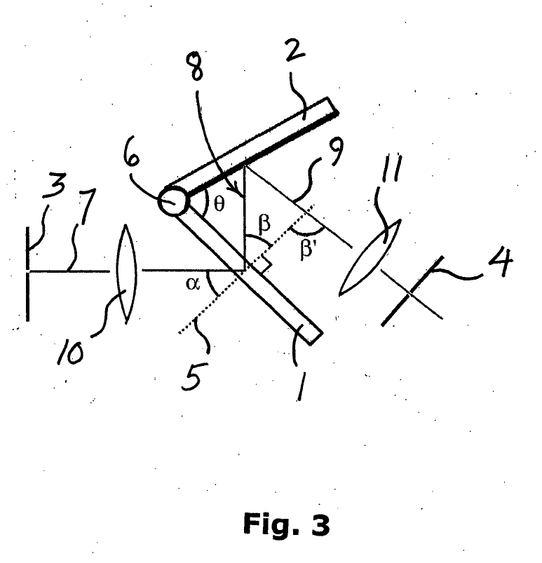

A monochrometer employing a tunable transmissive grating according to an embodiment of the invention is illustrated in FIG. 3. The monochrometer comprises a transmissive grating 1, input collimator 10, exit collimator 11, input slit 3, exit slit 4, and mirror 2, with collimators 10 positioned between the input slit 3 and the grating 1 and the collimator 11 positioned between mirror 2 and exit slit 4. The input beam 7 emits from the input slit 3 and passes through collimator 10 onto the grating 1, meeting the grating at an angle α from the grating normal 5. The diffracted beam 8 departs from the grating at angle β to the grating normal 5. The diffracted beam 8 reflects from the mirror 2 creating a reflected diffracted beam 9, which reflected diffracted beam 9 forms angle β′ from the grating normal 5. The reflected diffracted beam 9 passes through collimator 11 to the exit slit 4. The grating 1 and mirror 2 are rigidly joined at one end and the joint point acts as a rotation center 6 about which the grating and mirror assembly can be rotated to tune the wavelength of the output beam exiting at slit 4. The grating and mirror assembly can be rotated around rotation center 6 while keeping θ constant and holding to the constraint α+β′=constant

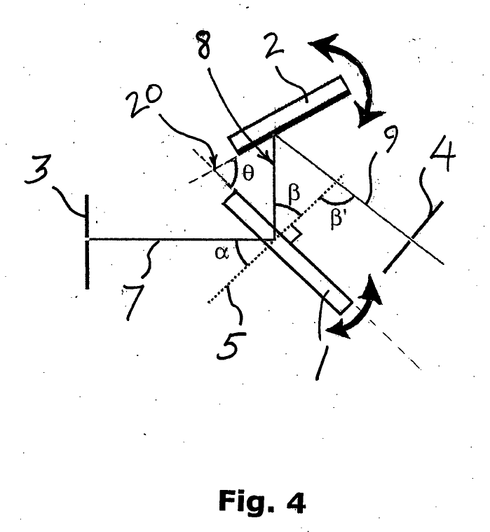

Referring to FIG. 4, in a further preferred embodiment of the invention the apparatus can include a transmissive dispersive element 1 having a first planar axis and a reflective element 2 having a second planar axis. The planes can be parallel, but preferably the axes intersect along a line of axial intersection (which axial intersection shows as intersection point 20 in the cross-sectional planar view of FIG. 4). An angle, θ, is formed between the planar axes of the elements. At least one of the elements is rotatable about a rotational axis. The rotational axis can lie on the planar axis of one or both elements or not on the axis of either element. If both elements are rotatable, then they may each have independent rotational axis lying on or off each element's planar axis. Further, each element could be rotatable around a rotational axis lying outside the element (on or off that element's axis) and that element, or the other element, or both elements, could be additionally rotatable about another rotational axis lying within the respective element(s).

In a number of embodiments, it is preferable that the rotational axis lying in the planar lies of the element (within the element or elsewhere along the axis), and is orthogonal to a line projecting from the element to the line of intersection of the axes.

In some embodiments, it is further preferable that both elements are rotatable about a common rotational axis, such as is shown in FIGS. 2, 3 and 6. Most preferably the common rotational axis coincides with the line of intersection common to the two planar axes. In FIGS. 2 and 3, this point of intersection coincides with rotational center 6. In FIG. 4, however, the point of intersection 20 is shown, but the elements can rotate either around the intersection point 20, or they can rotate around other, independent rotational centers on or off the elements' axes.

In FIG. 4, for example, a first optical path comprises an input beam 7 entering the transmissive dispersive element 1 to form dispersed beam 8 dispersing onto the reflective element 2 to create reflected dispersed beam 9 that reflects from the reflective element 2. Angle α is formed between the input beam 7 and a normal 5 to the axis of the dispersive element 1. Angle β is formed between the dispersed beam 8 and the normal 5. Angle β′ is formed between the reflected-dispersed beam 9 and the normal 5. A second optical path is formed by rotating at least one of the elements to alter angles α and β′, such that light passing from the dispersive element 1 is directed onto the reflective element 2 at a different angle than according to the first optical path. The change from the first to the second optical path tunes the wavelength of the output beam 9. The dispersive element 1 can be a rotatable transmissive grating that diffracts the input beam 7 and the reflective element 2 can be a rotatable mirror.

Referring again to FIG. 2, in one embodiment of the invention the rotational axis can be a rigid fixed joint, such that the angle θ remains constant, with both mirror and grating rotating together at the same angular rate about the rotational axis.

In some embodiments, however, even where the grating and mirror each have independent rotational axis, both elements can be rotated independently while still maintaining the condition that θ remains constant.

However, according to further embodiments of the invention, the transmissive grating 1 does not have to rotate with the mirror 2 to tune the wavelength of the reflected beam 9 diffracted from grating 1, since, as shown in connection with Eq. 6-Eq. 8 above, the reflected diffracted beam 9 has little dependence on the angle of the grating 1. Thus, multiple variations are possible to simplify the design, or to achieve better performance in certain applications.

Referring again to FIG. 2, another embodiment of the invention can provide for an apparatus wherein a relative angular movement between the dispersive element 1 and the reflector 2 causes a change in the relative angle from θ₁ to θ₂, thus causing light transmitted through the dispersive element 1 to be redirected from a first optical path to a second optical path. A specific and controllable change in wavelength of the reflected diffracted beam 9 reflecting from the reflector 2 is thereby tunable by the relative movement between the dispersive element 1 and the reflector 2.

As a further example, with reference to FIG. 4, an embodiment of the invention can provide for an apparatus wherein the mirror 2 is not attached to grating 1, but instead each element is controllably rotated independently, where angle θ is the angle between the projected axes of the grating 1 and mirror 2 when these axes are projected to a point of intersection. Then, rotating the mirror 2 only, without rotating the grating 1 will tune the output of the grating according to an embodiment of the invention (for example, useful in narrow-band tuning applications such as laser cavity). Further, rotating the mirror 2 at a different angle than the grating 1 is useful when the peak of grating efficiency is not at the Littrow condition but slightly off.

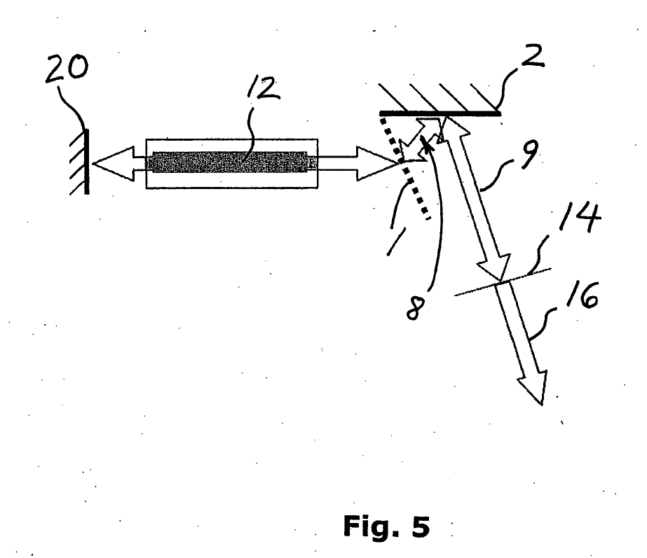

A tunable laser cavity employing a tunable transmissive grating according to an embodiment of the invention is shown in FIG. 5. Widely used tunable diode lasers and dye lasers commonly utilize a so-called Littrow or Littman cavity. FIG. 5 illustrates an example of a Littrow laser cavity with an improvement made by using a tunable transmissive grating according to a preferred embodiment of the invention, wherein a lasing medium 12 is formed between mirror 20 and grating 1, and a transmitted diffracted beam 8 is directed from a transmissive grating 1 onto a mirror 2 and the reflected diffracted beam 9 is utilized as output, and, further, wherein an output coupler 14 is positioned in the optical path of the diffracted beam 9 downbeam from the mirror 2, with an output beam 16 emitting from the output coupler 14. In one embodiment, the grating 1 and mirror 2 can comprise an assembly that can be rotated together around a common rotational center in order to tune the wavelength of the output beam 16. In additional embodiments grating 1 and mirror 2 can be independently rotatable, with either or both being rotated about a common rotational center or around independent rotational centers in order to tune the wavelength of the output beam 16.

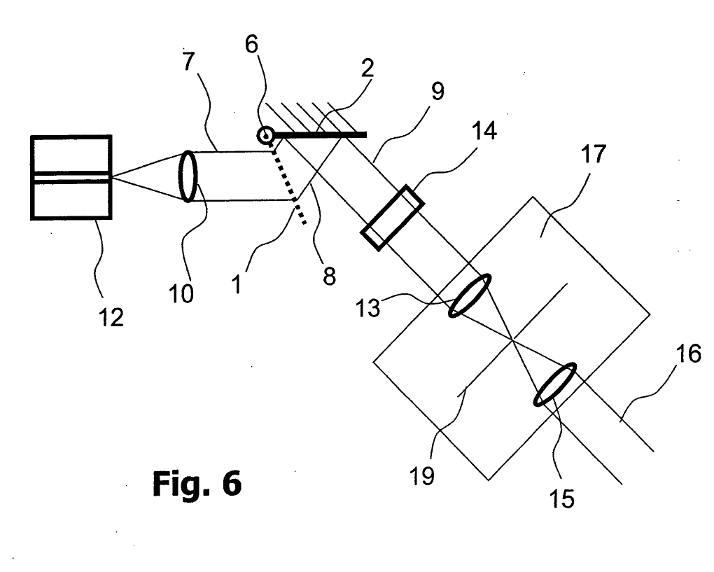

FIG. 6 shows a further example of a tunable diode laser cavity using a tunable transmissive grating according to a further embodiment of the invention. The apparatus can include diode laser 12 (single mode, λ=685 nm), collimator 10 (f=3.6 mm, numerical aperture (NA)=0.45), VPH grating 1 (1095 lpmm; diffraction efficiency>90%; available from Kaiser Optical Systems, Inc., Ann Arbor, Mich., or from Wasatch Photonics, Logan, Utah), flat silver mirror 2, rotational center 6, output coupler 14 (which can be a dielectric mirror with reflectivity about=40%), spatial filter 17 comprising lenses 13,15 and pinhole 19 of diameter 25 μm (f=50 mm; beam diameter=3.5 mm; 86% energy; M² factor<2). Alternatively, the transmissive grating 1 can be a fused silicon grating (available from Ibsen Photonics, Ryttermarken 15-21, DK-3520 Farum, Denmark), which provides better bandwidth performance but lower peak efficiency than the VPH grating. The output coupler 14 can have reflectivity in the range of 5-99%, with preferred reflectivity in the range of 10-40%.

Still referring to FIG. 6, the input beam 7 is directed onto the grating 1 by collimator 10. The dispersed beam 8 is directed along a first optical path onto the mirror 2, from which the reflected dispersed beam 9 is directed into output coupler 14. Light passing through the output coupler passes into the spatial filter 17, from which passes output beam 16. A rotation of the mirror 2 about the rotational axis 6 tunes the wavelength of the output beam 16. The spatial filter 17 is optional.

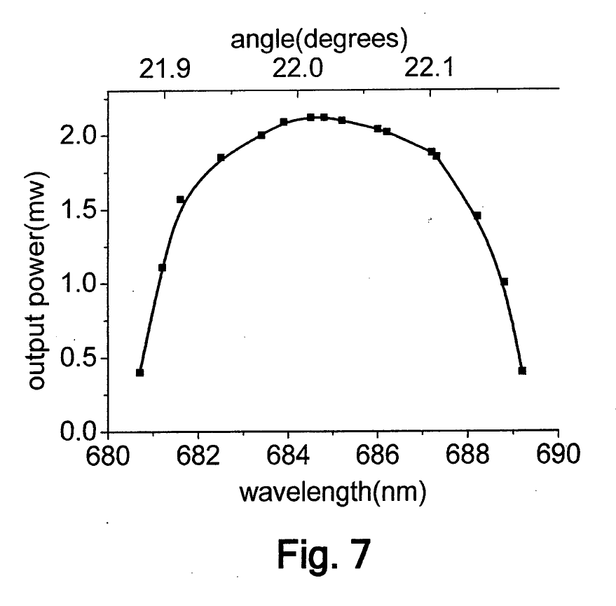

An important advantage of the invention relates to the higher efficiencies achievable in a tunable laser according to the invention. For the embodiment described in FIG. 6, a relationship can be described between output power (mW) and tunable wavelength (nm) in the diode laser cavity using a tunable transmissive grating according to an embodiment of the invention. This relationship is illustrated in FIG. 7, where the relative angle (degrees) of the grating-mirror assembly corresponding to the tuned wavelength is also illustrated. This curve shows, for at least one embodiment of the invention, that 75% of output power can be maintained over a 5 nm range (e.g., from 682-687 nm), when tuning wavelength by an angular rotation of the mirror-grating assembly by about 0.1 degrees in either direction from the peak setting. In one embodiment according to FIG. 6, for example, the energy of the beam passing through the apparatus is as follows: the input beam 7 has energy of 5.37 mW, the reflected dispersed beam 9 after the grating mirror assembly has energy of 4.75 mW, the beam leaving the coupler entering the spatial filter 3.03 mW and the output beam 16 after the spatial filter 17 has energy of 2.10 mW. This corresponds to 88.5% efficiency for the grating (92%) and mirror (96%). The output coupler 14 has about 40% reflectivity. The 92% grating efficiency remains nearly constant over the tuning range (e.g. from 682-687 nm) and the drop in output power near the end of the tuning range is due to the gain range of the laser gain medium.

The condition that θ remain constant during the angle-tuning operation, however, can provide measurable advantage over the case where θ varies during tuning. Essentially, rotating the mirror alone cause a loss in grating efficiency more quickly with respect to a plus/minus change in wavelength. The advantage of θ remaining constant relates to the fact that the degree of change in θ that will allow efficient or desired tuning is dependent on the wavelength range and the grating dispersion. This is because the grating efficiency has a quadratic dependency on θ near the maximum efficiency point. Therefore, varying θ increases the sensitivity of tuning efficiency to the change in wavelength.

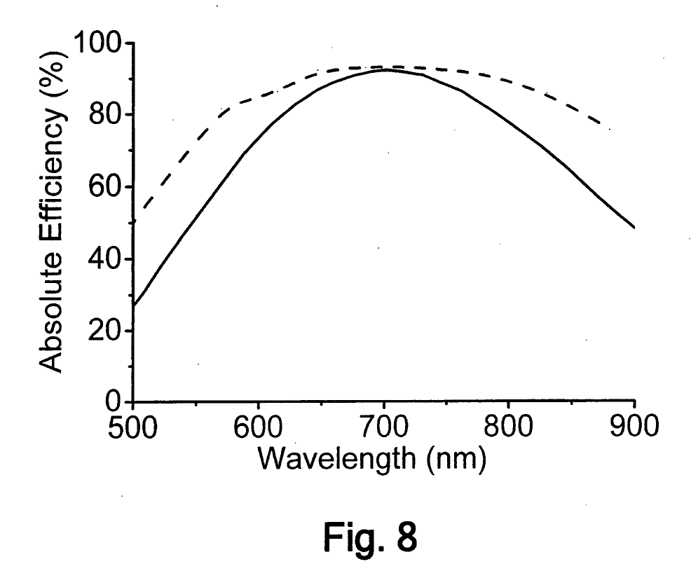

This can be seen, for example, in FIG. 8, which illustrates an efficiency curve for a tunable transmissive grating assembly according to a preferred embodiment of the invention. FIG. 8 contrasts the efficiency achieved by rotating the grating and the mirror together in order to tune the wavelength versus the efficiency achieved by holding the grating stationary while rotating only the mirror in order to tune the wavelength. When the grating does not rotate together with the mirror (See the solid line in FIG. 8) the efficiency drops much more quickly as the wavelength is tuned longer or shorter. For example, when tuning the wavelength from about 700 nm (corresponding to peak efficiency for this embodiment, with a 1095 lpmm VPHG grating optimized at 700 nm) to about 550 nm, if the grating rotates with the mirror then the efficiency is reduced to about 70% (dashed line); but, if only the mirror is rotated then the efficiency drops to about 50% (solid line).

Preferred methods for rotating, moving or deflecting one or more optical components of the apparatus such as, without limitation, one or more transmissive grating(s) and/or one or more mirror(s) with respect to one or more rotational center(s) include, inter alia, servo or stepper motor (for larger amounts of tuning), piezo (for more precise tuning in a small range), acoustic (for very fast tuning in a small range), magnetic methods (particularly useful when a motor is too bulky and making the instrument very small is desirable, and also has a moderately fast tuning speed). Different methods or combinations of methods can be used for different applications.

The advantages of the improved tunable laser cavity design employing a tunable transmissive grating assembly according to preferred embodiments of the invention include, without limitation: High spectral purity: The output is taken from 1^{st} order diffraction. Since the diffracted beam is used instead of a reflected beam, the beam is already ‘filtered’ right out of the cavity, suppressing both amplified spontaneous emission and sidemodes. Furthermore, the feedback is dispersed twice through the grating, which will result in narrower linewidth than Littrow configuration. In at least one embodiment ˜60 dB improvement can be expected. Applications to diode lasers can stabilize a single wavelength, without drift, with higher efficiency, to provide a free running diode without external feedback (where conventional designs have problems owing to thermal drift).

High output efficiency: transmissive gratings, which do not need metallic coatings, can have about 90-100% efficiency, while reflective gratings have much lower efficiencies owing to losses from the metal coatings. Moreover, the output from the Littrow cavity has to be filtered once again for applications requiring high spectral purity (such as Raman spectroscopy or fluorescence spectroscopy).

Design flexibility: Favorable combination of output efficiency and tunability. The reflectivity of the output coupler is an independent parameter, i.e., it can be designed independently of the grating, ensuring both the maximum tuning range and efficiency.

Power handling: reflective gratings cannot handle much power owing to the energy loss on their metal coatings. Power handling capability is particularly important for pulsed systems such as optical parametric oscillator cavity, and short pulse dye laser.

Design simplicity: Both the beam position and direction does not change when the wavelength is tuned, unlike in Littrow configuration. Further, in diode laser applications, the diode can be switched out easily.

Broader range of wavelengths available for tuning. For instance in diode laser applications, the source lasers are usually within 613-620 nm; but, the tunable transmissive grating assembly according to an embodiment of the invention can provide tuning of +/−100 nm.

Cost advantages: The tunable transmissive grating assembly has very low component costs, about ten-fold to forty-fold less expensive than conventional devices.

Applications of the invention include, but are not limited to using a tunable, fixed-joint, rotating, transmissive grating/mirror assembly or a transmissive grating with a rotating mirror in a monochrometer, a tunable laser cavity, a single, double or triple spectrometers, and/or in many Littrow-based diode laser applications.

Applications also include using tunable transmissive grating assemblies in lasers employed in super-cooled, atomic cryo-research, and in nano-material research (where signals are so low that signal loss is critical and the conventional use of triple monochrometers is costly and propagates errors). Embodiments can be employed generally in association with volume-phase holographic gratings.

A further embodiment, for example, provides for an X-ray monochrometer wherein the mirror rotates around a rotational point a small distance away from the geometric intersection of the central planes of the mirror and the transmissive grating.

Improvements for using a tunable transmissive grating apparatus according to preferred embodiments of the invention in the context of research applications have been demonstrated. For example, in a monochrometer, efficiency improvement of 20˜30% has been demonstrated for any type of grating-based monochrometer. When used for triple monochrometers, the efficiency improves by about 100%. Efficiency is important both for low-light applications such as astronomy, Raman spectroscopy and photoluminescence spectroscopy and for high-power applications such as for a high-power monochrometer using a tungsten light source. In a tunable laser cavity, efficiency improvement of 20˜30% has been demonstrated and spectral purity improves. Power-handling capability increases by about a factor of 10. Efficiency is important for any laser since it is directly related to the available output power. Spectral purity is important for many spectroscopic applications.

While the present invention has been described in conjunction with one or more preferred embodiment, one of ordinary skill in the relevant art, after reading the foregoing specification, will be able to effect various changes, substitutions of equivalents, and other alterations to the compositions and methods set forth herein. It is to be understood that the description herein is by way of example of equivalent devices and methods and not as a limitation to the scope of the invention as set forth in the claims. Therefore, all embodiments that come within the scope and spirit of the following claims and equivalents thereto are claimed as the invention.

What is claimed is:

1. An apparatus for tuning wavelengths of light through a transmissive dispersive element, comprising:
a transmissive dispersive element, and
a reflector, at least one of said dispersive element and reflector being movable such that said movement alters a wavelength of light transmitted by the dispersive element and reflected by the reflector.

2. The apparatus of claim 1 further comprising a light input path and a light output path, the dispersive element and the reflector being oriented at a fixed angle such the joint rotation of the dispersive element and reflector relative to a stationary input path causes a change in wavelength of light on a stationary output path.

3. The apparatus of claim 1 further comprising:
a first optical path such that an input light beam having a input vector projects onto the dispersive element, the dispersive element having a central axis, said beam then dispersing along a dispersion vector from the dispersive element onto the reflector and said beam then reflecting from the reflector along an output path having an output vector, the reflector having a central axis;
an angle α formed between the input vector and a normal to the central axis of the dispersive element; and
an angle β′ formed between the output vector and the normal to the central axis of the dispersive element, the apparatus being configured such that a movement of at least one of the element and the reflector produces a second optical path, while keeping the sum of angles α and β′ constant.

4. The apparatus of claim 3, further comprising:
an angle θ is formed between the central axis of the dispersive element and the central axis of the reflector; the apparatus being configured such that a movement of at least one of the element and the reflector produces a second optical path, while keeping the angle θ constant.

5. The apparatus of claim 1 wherein the apparatus is configured such that a change in wavelength of a light beam reflecting from the reflector is tunable by a rotational movement of at least one of the dispersive element and the reflector.

6. The apparatus of claim 1 wherein the apparatus is configured such that a change in wavelength of a light beam reflecting from the reflector is tunable by a rotational movement of the dispersive element and the reflector through the same angle.

7. The apparatus of claim 2 wherein the movement of the dispersive element and the reflector is a rotation about a rotational axis.

8. The apparatus of claim 5 wherein the rotational movement of the dispersive element and the reflector is a rotation about a rotational axis fixedly attached to the dispersive element and the reflector.

9. The apparatus of claim 8 wherein the rotational movement of the dispersive element and the reflector is a rotation about a rotational axis comprising a rigid joint fixedly adjacent to a side of the dispersive element and a side of the reflector.

10. The apparatus of claim 1 wherein the transmissive dispersive element is a transmissive grating.

11. The apparatus of claim 1 further comprising:
a joint attaching the dispersive element to the reflector, the joint including a rotational axis such that an angular position is formed between the dispersive element and reflector;
a first angular position and a second angular position of the reflector and dispersive element;
a first optical path such that light dispersing from the dispersive element is directed onto the reflector at the first relative angular position; and
a second optical path such that light dispersing from the dispersive element is directed onto the reflector at the second angular position.

12. The apparatus of claim 1 wherein the apparatus further comprises a monochrometer.

13. The apparatus of claim 1 wherein the apparatus further comprises a tunable laser cavity.

14. The apparatus of claim 1 wherein the apparatus comprises a double or triple spectrometer.

15. The apparatus of claim 10 wherein the transmissive grating is one a Volume Holographic Transmission (VHT) or a Fused Silica (FS) grating.

16. An apparatus for tuning wavelengths of light through a transmissive dispersive element, comprising:
a grating having a grating normal;
a reflector;
a first relative angular position θ formed between the the grating and the reflector;
a first optical path such that light dispersing from the dispersive element is directed onto the reflector and reflects at the first relative angular position θ;
a first relative angular position β′ formed between the grating normal and the light reflecting from the reflector according to the first optical path;
a second relative angular position β′ formed between the grating normal and the light reflecting from the reflector; and
a second optical path such that light dispersing from the dispersive element is directed onto the reflector and reflects at the second relative angular position β′.

17. The apparatus of claim 16 wherein a change in wavelength of a light beam reflecting from the reflector is tunable by the relative angular change between the grating normal and the light reflecting from the reflector.

18. The apparatus of claim 17 wherein the apparatus is configured such that a movement of at least one of the dispersive element and the reflector, the movement comprising a rotation about a rotational axis, causes a relative angular change between the grating normal and the light reflecting from the reflector.

19. The apparatus of claim 16 wherein the relative movement between the dispersive element and the reflector is a rotation about a rotational axis.

20. The apparatus of claim 16 wherein the relative movement between the dispersive element and the reflector is a rotation about a rotational axis rigidly attached to sides of the dispersive element and the reflector.

21. The apparatus of claim 16 wherein the relative movement between the dispersive element and the reflector is a rotation about a rotational axis, said axis being an intersection of a plane projecting from the dispersive element and a plane projecting from the reflector and said axis being the same for both the first and second relative angular positions.

22. A method of tuning the wavelength of an output beam in an optical instrument, comprising the steps of
providing a transmissive dispersive element and a reflector to provide a tuning device; and
providing relative movement between an input light path and the tuning device to alter a wavelength of light emitted by the tuning device.

23. The method of claim 22 further comprising:
fixedly joining a lateral edge of the dispersive element to a lateral edge of the reflector, the fixed joint comprising a rotational axis and a relative angular position θ formed between the dispersive element and reflector;
positioning the rotational center in a first rotational position;
providing an input light beam;
optically coupling the light beam along a first optical path onto the element and the reflector, wherein the input light beam having an input path vector projecting onto the dispersive element, said beam then dispersing along a dispersion vector from the dispersive element onto the reflector and said beam then reflecting from the reflector along an output path vector, an angle α being formed between the input vector and the normal to a central axis of the dispersive element, an angle β′ is formed between the output path vector and the normal to the central axis of the dispersive element; and
rotating the reflector and element together about the rotational axis.

24. The method of claim 23 further comprising rotating the element and the reflector together about the rotational axis to produce a second optical path, the input light beam being projected onto the dispersive element and directed onto the reflector while keeping θ constant and the sum of angles α and β′ constant, said rotation tuning the wavelength of the output light beam along the output path vector.

25. The method of claim 22 further comprising providing a dispersive element including a grating and a reflector including a mirror.
